(19) United States
(12) Patent Application Publication
(10) Pub. No.: US 2024/0204330 A1
(43) Pub. Date: Jun. 20, 2024

(54) ENERGY STORAGE CONTAINER AND METHOD AND DEVICE FOR MANUFACTURING ENERGY STORAGE CONTAINER

(71) Applicant: CONTEMPORARY AMPEREX TECHNOLOGY CO., LIMITED, Ningde (CN)

(72) Inventors: Haibin Su, Ningde (CN); Hao Luo, Ningde (CN); Haoran Peng, Ningde (CN); Zengzhong Wang, Ningde (CN)

(21) Appl. No.: 18/589,456

(22) Filed: Feb. 28, 2024

Related U.S. Application Data
(63) Continuation of application No. PCT/CN2021/121377, filed on Sep. 28, 2021.

(51) Int. Cl. H01M 50/251; H01M 10/04; H01M 10/627; H01M 10/6568; H01M 10/658; H01M 50/204; H01M 50/291; H01M 50/505; H01M 50/691

(52) U.S. Cl. CPC H01M 50/251; H01M 10/0404; H01M 10/627; H01M 10/6568; H01M 10/658; H01M 50/204; H01M 50/291; H01M 50/505; H01M 50/691; H01M 2220/10

(57) ABSTRACT

Provided are an energy storage container and a method and a device for manufacturing an energy storage container. The energy storage container includes: multiple battery compartments arranged consecutively in a first direction, where each battery compartment in the multiple battery compartments is configured to accommodate multiple batteries, each battery compartment includes a side wall and a bracket, the bracket is disposed on the side wall, the bracket is configured to carry the batteries, and two adjacent battery compartments in the multiple battery compartments share a same side wall; and a main control box compartment, where the main control box compartment and the multiple battery compartments are arranged in a second direction, the second direction being perpendicular to the first direction.

### CROSS REFERENCE TO RELATED APPLICATIONS

The present application is a continuation of International Application PCT/CN2021/121377, filed Sep. 28, 2021 and entitled “ENERGY STORAGE CONTAINER AND METHOD AND DEVICE FOR MANUFACTURING ENERGY STORAGE CONTAINER”, the entire disclosure of which is incorporated herein by reference.

### TECHNICAL FIELD

This application relates to the field of energy storage technologies, and in particular, to an energy storage container and a method and a device for manufacturing an energy storage container.

### BACKGROUND

In the context of increasing support for the development of new energy technologies globally, a variety of technologies related to energy storage have been widely used, among which containers as a way to store energy are widely used. To increase energy density in containers, how batteries, control components, and cooling components in the containers are properly arranged is an in-depth study topic in academic circles.

### SUMMARY

Embodiments of this application provide an energy storage container and a method and a device for manufacturing an energy storage container, able to effectively increase energy storage density of the energy storage container.

A first aspect provides an energy storage container, including: multiple battery compartments arranged consecutively in a first direction, where each battery compartment in the multiple battery compartments is configured to accommodate multiple batteries, each battery compartment includes a side wall and a bracket, the bracket is disposed on the side wall, the bracket is configured to carry the battery, and two adjacent battery compartments in the multiple battery compartments share a same side wall; and a main control box compartment, where the main control box compartment and the multiple battery compartments are arranged in a second direction, the second direction being perpendicular to the first direction, and the main control box compartment is configured to accommodate a main control box, the main control box being configured to electrically connect the batteries in the multiple battery compartments.

Therefore, the energy storage container in the embodiments of this application is provided with multiple consecutively arranged battery compartments, and the multiple battery compartments share a same wall; or the energy storage container is provided with multiple partitions arranged in the first direction to form multiple battery compartments, so that batteries can be directly disposed in this container, discarding configuration of traditional battery cabinets. In this way, except for a box body structure of the energy storage container, it is unnecessary to additionally dispose multiple cabinets, which reduces space occupied by the original battery cabinet and increases energy density of the energy storage container. Moreover, the multiple battery compartments remain independent of each other, which can limit risks such as thermal runaway to a small space, ensuring safety performance of the energy storage container. In addition, the main control box compartment accommodating the main control box and the multiple battery compartments are disposed in the second direction to properly utilize the space of the energy storage container, improving space utilization and maintainability of the energy storage container.

In some embodiments, a side wall shared by the two adjacent battery compartments is a corrugated plate. This can prevent the spread of thermal runaway, improving overall thermal safety performance of the energy storage container.

In some embodiments, a wall of each battery compartment includes a first compartment door and a first wall intersecting with the first compartment door, where a plane in which the first compartment door is located is parallel to the first direction and the second direction, and a first seal ring is provided between the first compartment door and the first wall so that when the first compartment door is closed, the battery compartment in which the first compartment door is located is sealed.

This can prevent production of condensed water, and can also prevent rainwater and foreign objects outside the energy storage container from entering the battery compartment.

In some embodiments, an outer wall of the multiple battery compartments is a first sandwich structure, where the first sandwich structure is provided with first insulation cotton, and the outer wall of the multiple battery compartments is a wall other than the side wall shared by two adjacent battery compartments in the multiple battery compartments.

The provision of the first insulation cotton can reduce temperature difference of the battery compartments, prolong service life of the internal batteries, and prevent a large amount of condensed water produced in the battery compartment from corroding the batteries.

In some embodiments, each battery compartment is configured to accommodate multiple columns of batteries arranged in a third direction, where each of the multiple columns of batteries includes multiple batteries arranged in the second direction.

In some embodiments, the container includes multiple columns of the main control box compartments arranged in the third direction, where each column of the main control box compartments includes the multiple main control box compartments arranged consecutively in the first direction.

The main control box in the main control box compartment can implement electrical connection of multiple batteries, for example, multiple batteries can be connected in series.

In some embodiments, a support beam is provided between two adjacent ones of the multiple columns of main control box compartments, where the support beam is configured to support the multiple battery compartments.

In some embodiments, the support beam includes an upper wing plate, a web plate, and a lower wing plate, where the upper wing plate and the lower wing plate are parallel to each other, the web plate connects the upper wing plate and the lower wing plate and is perpendicular to the upper wing plate and the lower wing plate, the upper wing plate is attached to the wall shared between the multiple battery compartments and the main control box compartment, and the web plate is a side wall shared between the two adjacent columns of the main control box compartments.

The support beam of such shape can withstand great pressure from the batteries in the battery compartment, increasing bending resistance and overall structural strength of the container in a length direction.

In some embodiments, a wall of the main control box compartment includes a second compartment door and a second wall intersecting with the second compartment door, where a plane in which the second compartment door is located is parallel to the first direction and the second direction, and a second seal ring is provided between the second compartment door and the second wall so that when the second compartment door is closed, the main control box compartment is sealed, thereby preventing rainwater from entering the compartment to cause a short circuit.

In some embodiments, the container further includes a heat management component compartment, where the multiple battery compartments and the heat management component compartment are arranged in the first direction, the heat management component compartment is configured to accommodate a heat management component, and the heat management component is configured to regulate temperature inside the container.

In some embodiments, the main control box compartment is provided with a pipe clamp, where the pipe clamp is configured to fasten a water-cooled pipe, the water-cooled pipe is connected to the heat management component, and the water-cooled pipe is disposed on a side of the main control box farther away from the multiple battery compartments, so as to regulate temperature of the main control box.

In some embodiments, the container further includes an electrical compartment, where the electrical compartment and the multiple battery compartments are arranged in the first direction.

In some embodiments, the electrical compartment is configured to accommodate at least one of the following components: a power distribution box, a general control box, a fire control box, and a fan.

In some embodiments, a wall of the electrical compartment is a second sandwich structure, and the second sandwich structure is provided with second insulation cotton. The second insulation cotton can reduce temperature difference inside the electrical compartment and prolong service life of the internal electrical device.

In some embodiments, a wall of the electrical compartment includes a fourth compartment door and a fourth wall intersecting with the fourth compartment door, where a plane in which the fourth compartment door is located is perpendicular to the first direction, and a fourth seal ring is provided between the fourth compartment door and the fourth wall so that when the fourth compartment door is closed, the electrical compartment is sealed, thereby preventing rainwater from entering the compartment to cause a short circuit.

In some embodiments, the container further includes a busbar compartment, where the busbar compartment and the main control box compartment are arranged in the first direction, the busbar compartment is configured to accommodate a busbar component, and the busbar component is configured to be electrically connected to the main control box. For example, the busbar component can be configured to connect multiple main control boxes in parallel.

In some embodiments, a side of the busbar component farther away from the main control box compartment is provided with a transparent panel, and a side of the transparent panel farther away from the busbar component is provided with a sealing panel assembly, where the sealing panel assembly is a wall of the busbar compartment, and the scaling panel assembly is configured to seal the busbar compartment to prevent external rainwater from entering inside to short-circuit the internal busbar component.

According to a second aspect, a method for manufacturing an energy storage container is provided, including: providing multiple battery compartments, where the multiple battery compartments are arranged consecutively in a first direction, each battery compartment in the multiple battery compartments is configured to accommodate multiple batteries, each battery compartment in the multiple battery compartments includes a side wall and a bracket, the bracket is disposed on the side wall, the bracket is configured to carry the batteries, and two adjacent battery compartments in the multiple battery compartments share a same side wall; and providing a main control box compartment, where the main control box compartment and the multiple battery compartments are arranged in a second direction, the second direction being perpendicular to the first direction, and the main control box compartment is configured to accommodate a main control box, the main control box being configured to electrically connect the batteries in the multiple battery compartments.

According to a third aspect, a device for manufacturing an energy storage container is provided, including modules for performing the method in the second aspect described above.

### BRIEF DESCRIPTION OF DRAWINGS

FIG. 1 is a schematic diagram of an external structure of an energy storage container according to an embodiment of this application;

FIG. 2 is a schematic diagram of an internal structure of an energy storage container according to an embodiment of this application;

FIG. 3 is a schematic cross-sectional view of an energy storage container according to an embodiment of this application;

FIG. 4 is a schematic diagram of a support beam according to an embodiment of this application;

FIG. 5 is a partially enlarged view of a main control box compartment according to an embodiment of this application;

FIG. 6 is another cross-sectional schematic view of an energy storage container according to an embodiment of this application;

FIG. 7 is a schematic diagram of a rear wall of an energy storage container according to an embodiment of this application;

FIG. 8 is a schematic diagram of a front wall of an energy storage container according to an embodiment of this application;

FIG. 9 is still another cross-sectional schematic view of an energy storage container according to an embodiment of this application;

FIG. 10 is yet another cross-sectional schematic view of an energy storage container according to an embodiment of this application;

FIG. 11 is a schematic flowchart of a method for manufacturing an energy storage mechanism according to an embodiment of this application; and

FIG. 12 is a schematic block diagram of a device for manufacturing an energy storage mechanism according to an embodiment of this application.

In the accompanying drawings, the figures are not drawn to scale.

### DESCRIPTION OF EMBODIMENTS

The following further describes the implementations of this application in detail with reference to the accompanying drawings and embodiments. The detailed description of embodiments and the accompanying drawings are intended to illustrate the principle of this application, rather than to limit the scope of this application, meaning this application is not limited to the embodiments described herein.

In the description of this application, it should be noted that, unless otherwise stated, “a plurality of” means at least two; and the orientations or positional relationships indicated by the terms “upper”, “lower”, “left”, “right”, “inside”, “outside”, and the like are merely for case and brevity of description of this application rather than indicating or implying that the apparatuses or components mentioned must have specific orientations or must be constructed or manipulated according to specific orientations. These terms shall therefore not be construed as limitations on this application. In addition, the terms “first”, “second”, and “third”, and the like are merely for the purpose of description and shall not be understood as any indication or implication of relative importance. “Perpendicular” is not perpendicular in the strict sense but within an allowable range of error. “Parallel” is not parallel in the strict sense but within an allowable range of error.

The orientation terms appearing in the following description all refer to the orientations as shown in the drawings, and do not limit the specific structure of this application. In the description of this application, it should also be noted that unless otherwise specified and defined explicitly, the terms “mount”, “connect”, and “join” should be understood in their general senses. For example, they may refer to a fixed connection, a detachable connection, or an integral connection, and may refer to a direct connection or an indirect connection via an intermediate medium. A person of ordinary skill in the art can understand specific meanings of these terms in this application as appropriate to specific situations.

An energy storage container is a highly integrated energy storage device. Currently, multiple batteries are generally connected in series and put into one battery cabinet, and then multiple such battery cabinets are disposed in parallel into an energy storage container. In addition, considering transportation of the energy storage container, energy storage containers of standard dimensions are used to reduce transportation costs and transportation difficulty. However, limited by size, the energy storage container of standard dimensions can accommodate only a limited number of battery cabinets, leading to a low energy density of the energy storage container. Therefore, how energy density of the energy storage container is increased is one of the urgent problems to be resolved.

Therefore, an embodiment of this application provides an energy storage container capable of resolving the foregoing problems.

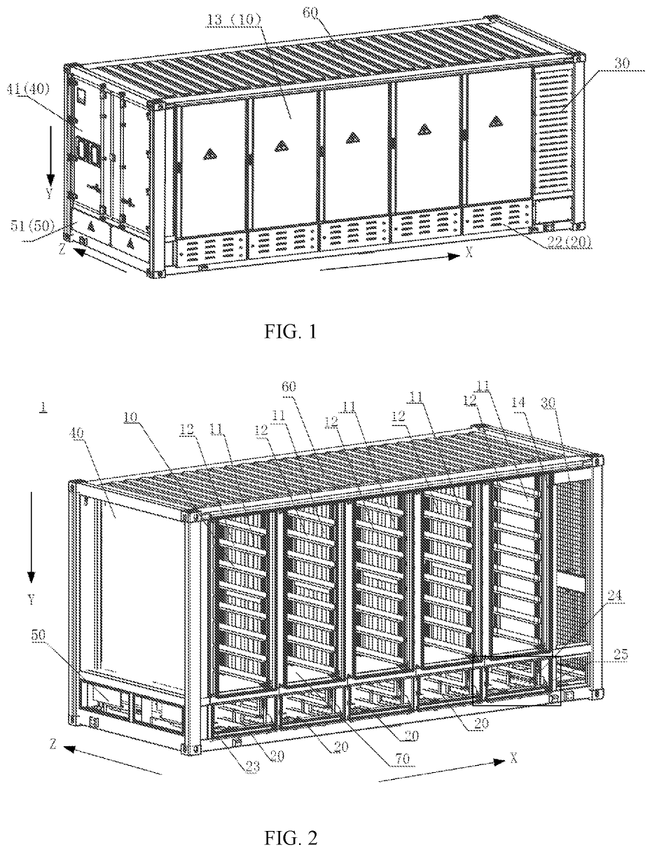

FIG. 1 is a schematic diagram of an outer surface of an energy storage container 1 according to this application, and FIG. 2 is a schematic diagram of the interior of the energy storage container 1 according to an embodiment of this application. As shown in FIG. 1 and FIG. 2, the container 1 in the embodiments of this application includes: multiple battery compartments 10 arranged consecutively in a first direction X, where each battery compartment 10 in the multiple battery compartments 10 is configured to accommodate multiple batteries, each battery compartment 10 in the multiple battery compartments includes a side wall 11 and a bracket 12, the bracket 12 is disposed on the side wall 11, the bracket 12 is configured to carry the batteries, and two adjacent battery compartments 10 in the multiple battery compartments 10 share a same side wall 11; and a main control box compartment 20, where the main control box compartment 20 and the multiple battery compartments 10 are arranged in a second direction Y, the second direction Y being perpendicular to the first direction X, and the main control box compartment 20 is configured to accommodate a main control box, the main control box being configured to electrically connect the batteries in the multiple battery compartments 10.

In the embodiments of this application, the energy storage container 1 is provided with multiple consecutively arranged battery compartments 10, with some walls shared between the multiple battery compartments 10; or the container 1 is provided with multiple partitions arranged in the first direction X to form multiple battery compartments 10, so that batteries can be directly disposed in the container 1, discarding configuration of traditional battery cabinets. In this way, except for a box body structure of the container 1, it is unnecessary to additionally dispose multiple cabinets, which reduces space occupied by the original battery cabinet and increases energy density of the container 1. Moreover, the multiple battery compartments 10 remain independent of each other, which can limit risks such as thermal runaway to a small space, ensuring safety performance of the container 1. In addition, the main control box compartment 20 accommodating the main control box and the multiple battery compartments 10 are disposed in the second direction Y, which properly utilizes the space of the container 1, improving space utilization and maintainability of the container 1.

It should be understood that the container 1 in the embodiments of this application may be a hollow structure, for example, the container 1 herein is a rectangular structure as an example. In addition, to facilitate transportation and reduce transportation costs, the energy storage container 1 in the embodiments of this application may be a container of standard dimensions. For example, a 20-foot or 40-foot container may be used, but the embodiments of this application are not limited thereto.

For case of description, in the embodiments of this application, three directions are defined based on a rectangular container 1, where six faces of the rectangular container are six outer walls of the energy storage container 1. Specifically, as shown in FIG. 1 and FIG. 2, the first direction X in the embodiments of this application may be a length direction of the container 1, and two of the six outer walls of the container 1 that are perpendicular to the first direction X are referred to as a front wall and a rear wall according to their sequence in the first direction X as shown in FIG. 1 and FIG. 2, and accordingly, the front and back of the container 1 may also be defined. The second direction Y in the embodiments of this application may be a height direction of the container 1, and two of the six outer walls of the container 1 that are perpendicular to the second direction Y are referred to as a top wall 60 and a bottom wall according to their sequence in the second direction Y as shown in FIG. 1 and FIG. 2, and accordingly, the top and bottom of the container 1 may also be defined. The third direction Z in the embodiments of this application may be a width direction of the container 1, and two of the six outer walls of the container 1 that are perpendicular to the third direction Z are referred to as a right wall and a left wall according to their sequence in the third direction Z as shown in FIG. 1 and FIG. 2, and accordingly, the left and right of the container 1 may also be defined.

Optionally, as shown in FIG. 1 and FIG. 2, the container 1 may further include a heat management component compartment 30, where the multiple battery compartments 10 and the heat management component compartment 30 are arranged in the first direction X, and the heat management component compartment 30 is configured to accommodate the heat management component.

Optionally, as shown in FIG. 1 and FIG. 2, the container 1 may further include an electrical compartment 40, where the electrical compartment 40 and the multiple battery compartments 10 are arranged in the first direction X, which means that the container 1 has the electrical compartment 40, the multiple battery compartments 40, and the heat management component compartment 30 arranged in order in the first direction X.

Optionally, as shown in FIG. 1 and FIG. 2, the container 1 may further include a busbar compartment 50, where the busbar compartment 50 and the main control box compartment 20 are arranged in the first direction, the busbar compartment 50 is configured to accommodate a busbar component, and the busbar component is configured to be electrically connected to the main control box.

The following first describes the battery compartment 10 in the embodiments of this application in detail with reference to the accompanying drawings. As shown in FIG. 1 and FIG. 2, the container 1 is provided with multiple battery compartments 10 arranged consecutively in the first direction X. In the figure, only five battery compartments 10 are used as an example for description.

It should be understood that side walls 11 of the multiple battery compartments 10 in the embodiment of this application may include a side wall 11 shared by any two adjacent battery compartments 10, and the side wall 11 shared by the two adjacent battery compartments 10 may be a corrugated plate, which can prevent the spread of thermal runaway, improving overall thermal safety performance of the container 1. In addition, the side walls 11 of the multiple battery compartments 10 may further include a side wall 11 of a frontmost battery compartment 10, where the side wall 11 is a wall shared by the battery compartment 10 and the electrical compartment 40; and the side walls 11 of the multiple battery compartments 10 may further include a side wall 11 of a rearmost battery compartment 10, where this side wall 11 is a wall shared by the battery compartment 10 and the heat management component compartment 30.

As shown in FIG. 1 and FIG. 2, walls of each battery compartment 10 include a first compartment door 13 and a first wall intersecting with the first compartment door 13, where a plane in which the first compartment door 13 is located is parallel to the first direction X and the second direction Y, or the plane in which the first compartment door 13 is located is perpendicular to the third direction Z. For example, in FIG. 1 and FIG. 2, each battery compartment 10 includes two first compartment doors 13 respectively on the left and right, meaning that the batteries on the left and right sides of the battery compartment 10 can be put into and taken out by opening the two first compartment doors 13 on the left and right respectively.

It should be understood that the first wall of the rectangular battery compartment 10 intersecting with the first compartment door 13 may include four walls. The first wall may include two side walls 11 of each battery compartment 10, further includes a portion of the top wall 60 of the container 1 corresponding to each battery compartment 10, and may further include a wall 70 located below the battery compartment 10 and parallel to the top wall 60, where the wall 70 is a wall 70 shared by the battery compartment 10 and the main control box compartment 20.

Optionally, a first seal ring 14 may be provided between the first compartment door 13 and the first wall. For example, the first seal ring 14 may be provided at a position on the first wall that intersects with the first compartment door 13 so that when the first compartment door 13 is closed, the battery compartment 10 in which the first compartment door 13 is located is sealed, to prevent production of condensed water, and prevent rainwater and foreign objects outside the container 1 from entering the battery compartment 10.

Each battery compartment 10 in the embodiment of this application is a separate compartment, and each battery compartment 10 can be configured to accommodate multiple batteries. Specifically, each battery compartment 10 can be configured to accommodate multiple columns of batteries arranged in the third direction Z, where each of the multiple columns of batteries includes multiple batteries arranged in the second direction Y. For example, considering width of the container 1, in FIG. 2, each battery compartment 10 accommodates two columns of batteries arranged in the third direction Z, each column including eight batteries arranged in the second direction Y.

Correspondingly, each battery compartment 10 includes a side wall 11 perpendicular to the first direction X and a bracket 12 provided on the side wall 11, where the bracket 12 is configured to carry the battery. For example, in FIG. 2, each battery compartment 10 includes two sets of brackets 12 in left-right mirror symmetry, each set of brackets 12 including eight pairs of brackets 12. Each set of brackets 12 is configured to carry a column of batteries, and each pair of brackets 12 includes two brackets 12 disposed opposite each other on a same horizontal plane for carrying one or more batteries. For example, a pair of brackets 12 in FIG. 2 can be configured to carry one battery, then the brackets 12 in each battery compartment 10 can be configured to carry 16 batteries, maximizing energy density of the container 1.

It should be understood that the connection manner of the batteries accommodated in the battery compartment 10 in the embodiments of this application may include series and parallel connection. For example, the batteries may be electrically connected through the main control box in the main control box compartment 20. Specifically, the container 1 in the embodiment of this application may include multiple main control box compartments 20, and the main control box in each main control box compartment 20 may be configured for electrical connection of batteries in a same battery compartment 10 or electrical connection of batteries in multiple battery compartments 10. In addition, the main control box compartment 20 in the embodiment of this application is located below the battery compartment 10, which is easy to maintain due to its low position.

For example, the container 1 may include multiple columns of such main control box compartment 20 arranged in the third direction Z, where each column of such main control box compartment 20 includes the multiple main control box compartments 20 arranged consecutively in the first direction X. Specifically, for example, as shown in FIG. 1 and FIG. 2, the container 1 includes two columns of the main control box compartment 20 arranged in the third direction Z, and each column of the main control box compartment 20 includes five main control box compartments 20 arranged consecutively in the first direction X. The number of columns of the main control box compartments 20 is consistent with the number of columns of batteries included in each battery compartment 10, and the multiple main control box compartments 20 in each column of the main control box compartment 20 are in one-to-one correspondence to the multiple battery compartments 10, to be specific, one main control box compartment 10 can correspond to a column of batteries above it. For example, one main control box compartment 10 in FIG. 2 can correspond to eight batteries in the same battery compartment 10 above it, and one battery compartment 10 correspondingly has effect on two main control box compartments 20.

Optionally, one main control box compartment 20 may correspond to a column of batteries in the same battery compartment 10 above it, and may be configured to connect this column of batteries in series. For example, each main control box compartment 20 may be provided with a main control box, where the main control box may be supported by brackets provided on the side wall of the main control box compartment 20 to fasten the main control box.

As shown in FIG. 1 and FIG. 2, walls of each main control box compartment 20 may include a second compartment door 22 and a second wall intersecting with the second compartment door 22, where a plane in which the second compartment door 22 is located is parallel to the first direction X and the second direction Y, or the second compartment door 22 is perpendicular to the third direction Z, and the second compartment door 22 may be disposed parallel to the first compartment door 13. The second wall may include two side walls of the main control box compartment 20, further includes a wall 70 shared between the main control box compartment 20 and the battery compartment 10, and may further include the bottom wall of the container 1.

Optionally, a second seal ring 23 may be provided between the second compartment door 22 and the second wall so that when the second compartment door 22 is closed, the main control box compartment 20 is sealed to prevent rainwater from entering the compartment to cause a short circuit.

Optionally, as shown in FIG. 1, the second compartment door 22 of the main control box compartment 20 may be provided with louvered holes, which facilitates heat dissipation of the main control box.

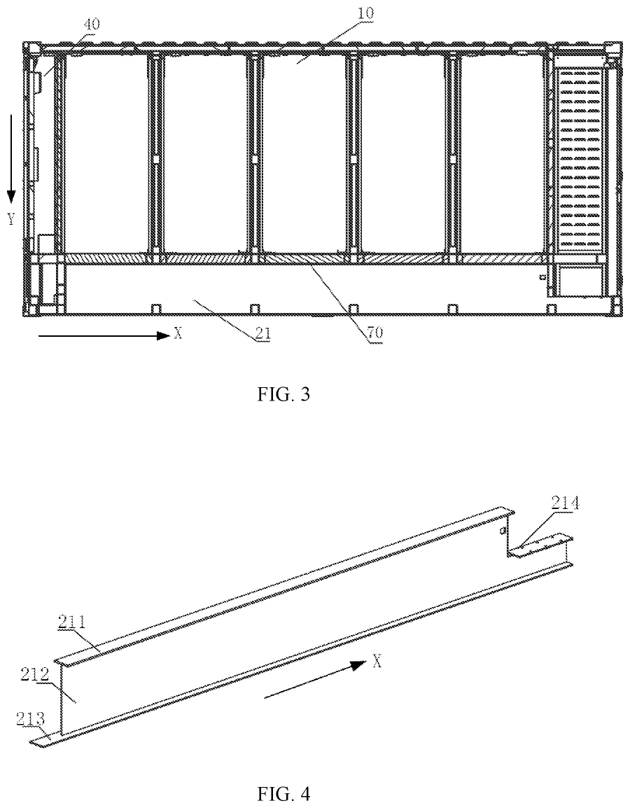

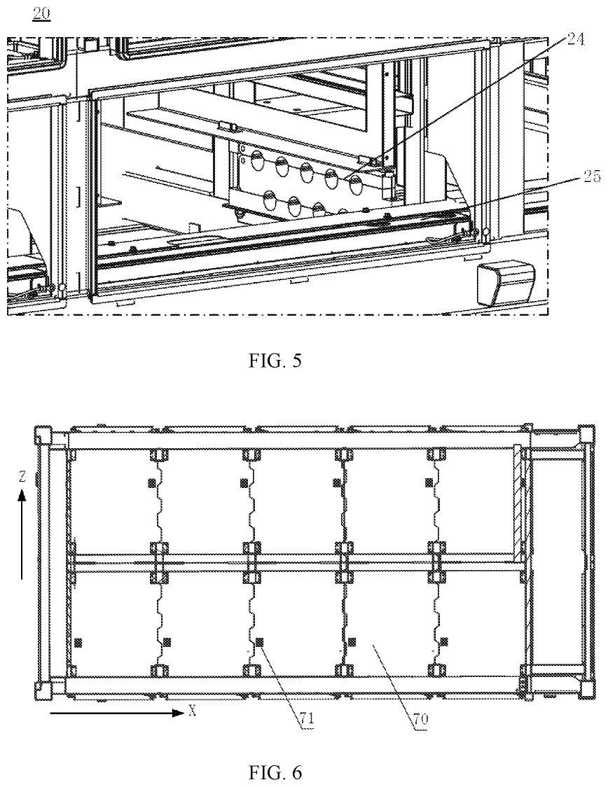

Optionally, a support beam 21 is provided between two adjacent ones of the multiple columns of main control box compartments 20, where the support beam 21 is configured to support the multiple battery compartments 10. Specifically, FIG. 3 is a cross-sectional view of the container 1 in the embodiment of this application, and the cross-section is a plane perpendicular to the third direction Z. FIG. 4 is a schematic view of the support beam 21. As shown in FIG. 3 and FIG. 4, the support beam 21 provided between two adjacent columns of the main control box compartment 20 may be an H-shaped structure. The support beam 21 includes an upper wing plate 211, a web plate 212, and a lower wing plate 213, where the upper wing plate 211 and the lower wing plate 213 are parallel to each other, and the web plate 212 connects the upper wing plate 211 and the lower wing plate 213 and is perpendicular to the upper wing plate 211 and the lower wing plate 213. Specifically, the upper wing plate 211 is attached to the wall 70 shared between the multiple battery compartments 10 and the main control box compartment 20, the web plate 212 is a side wall shared between two adjacent columns of the main control box compartments 20, and the lower wing plate 213 is attached to the bottom wall of the container 1.

Optionally, the support beam 21 may further include an avoidance region 214, where the avoidance region 214 may be configured to avoid components inside the container 1. For example, as shown in FIG. 3 and FIG. 4, the avoidance region 214 may be provided at the intersection of the main control box compartment 20 and the heat management component compartment 30 to avoid the components provided in the heat management component compartment 30, but the embodiments of this application are not limited thereto.

Optionally, the support beam 21 may be made from Q235 steel and be an H-shape structure, enabling the support beam 21 to withstand great pressure from the batteries in the battery compartment, and increasing bending resistance and overall structural strength of the container 1 in the length direction.

It should be understood that the main control box compartment 20 may be further provided with other structures. For example, each main control box compartment 20 may further include a pipe clamp 24 and a wire slot 25. FIG. 5 is an enlarged view of area A in FIG. 2. As shown in FIG. 5, each main control box compartment 20 is provided with a wire slot 25, where the wire slot 25 may be configured to accommodate wire harnesses. As shown in FIG. 5, each main control box compartment 20 may also be provided with a pipe clamp 24, where the pipe clamp 24 is configured to fasten a water-cooled pipe, for example, the water-cooled pipe is disposed on a side of the main control box farther away from the multiple battery compartments 10, and the water-cooled pipe may be connected to the heat management component in the heat management component compartment 20 to regulate temperature inside the main control box compartment 20.

Optionally, the bottoms of the multiple main control box compartments 20 may communicate with each other; correspondingly, the wire slots 25 in the multiple main control box compartments 20 may also communicate with each other, and the wire harnesses accommodated therein may also communicate with each other; and the water-cooled pipes fastened by the pipe clamps 24 of the multiple main control box compartments 20 may also communicate with each other. This facilitates both installation and maintenance.

FIG. 6 is another cross-sectional view of the energy storage container 1 in an embodiment of this application, and the cross-section is an upper surface of the wall 70 shared between the multiple battery compartments 10 and the main control box compartment 20. As shown in FIG. 6, the wall 70 shared between the multiple battery compartments 10 and the main control box compartment 20 may be further provided with a drain valve 71, where the drain valve 71 is configured to drain liquid from the battery compartment 10. Specifically, the liquid in the battery compartment 10 can be drained through the drain valve 71 along a drainage path provided between the battery compartments 10 and the main control box compartment 20. For example, a small amount of condensed water produced in the battery compartments 10 can be drained, and accidentally leaked cooling liquid can also be drained, preventing accumulation of condensed water and cooling liquid from damaging the batteries.

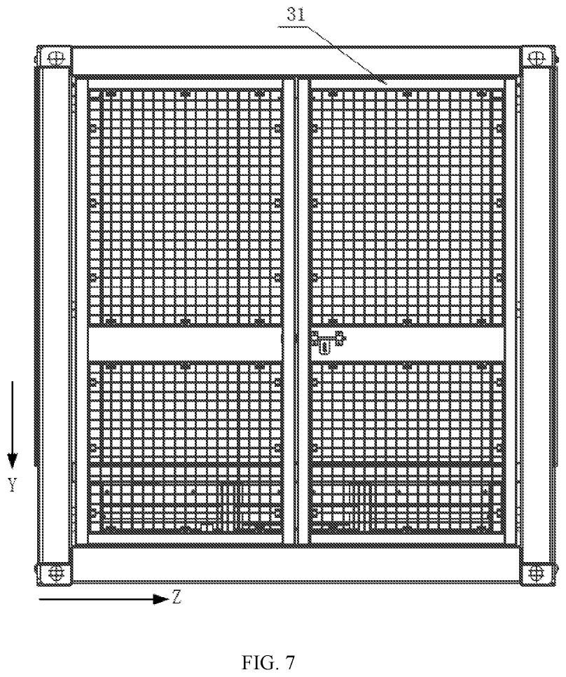

FIG. 7 is a schematic view of the rear wall of the energy storage container 1 in an embodiment of this application. With reference to FIG. 2 and FIG. 7, it can be learned that the heat management component compartment 30 is provided behind the battery compartment 10 of the container 1, and a wall of the heat management component compartment 30 includes a third compartment door 31, where the third compartment door 31 may be the rear wall of the container 1, meaning that the third compartment door 31 is perpendicular to the first direction X.

Optionally, the third compartment door 31 is provided with through holes arranged in a grid pattern to allow the heat management component compartment 30 to communicate with the outside for easy heat dissipation and maintenance.

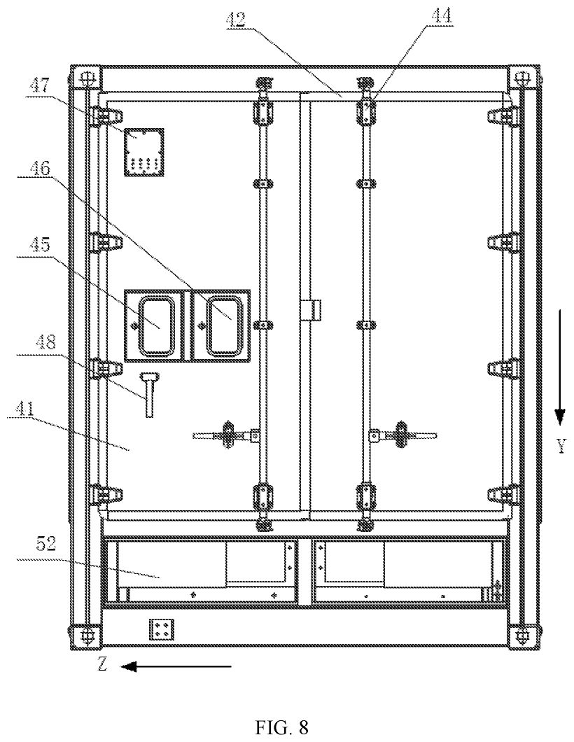

FIG. 8 is a schematic view of the front wall of the energy storage container 1 in an embodiment of this application. With reference to FIG. 1, FIG. 2, and FIG. 8, it can be learned that the electrical compartment 40 and the busbar compartment 50 are respectively provided in front of the battery compartment 10 and the main control box compartment 20 of the container 1. A wall of the electrical compartment 40 includes a fourth compartment door 41, and the busbar compartment 50 includes a sealing panel assembly 51, where the fourth compartment door 41 and the sealing panel assembly 51 may serve as the front wall of the container 1, and the fourth compartment door 41 and the sealing panel assembly 51 are both perpendicular to the first direction X.

The electrical compartment 40 in the embodiment of this application may be configured to accommodate an electrical device, for example, may be configured to accommodate at least one of the following components: a power distribution box, a general control box, a fire control box, and a fan.

As shown in FIG. 8, the wall of the electrical compartment 40 include the fourth compartment door 41 and a fourth wall intersecting with the fourth compartment door 41, where the fourth wall may include a portion of the top wall 60 of the container 1, a portion of the wall 70, and two side walls perpendicular to the third direction Z. A fourth seal ring 42 is provided between the fourth compartment door 41 and the fourth wall so that when the fourth compartment door 41 is closed, the electrical compartment 40 is sealed. Specifically, the fourth compartment door 41 may be further provided with a long rod lock 44. When the door is closed, the long rod lock 44 presses the fourth compartment door 41, so that the fourth compartment door 41 is tightly attached to the box body through the fourth seal ring 42 to achieve a sealing effect, preventing rainwater from entering the electrical compartment 40 to short-circuit the internal electrical device.

Optionally, the fourth compartment door 41 may be further provided with other components. For example, the fourth compartment door 41 is provided with at least one of the following structures: an emergency hand pull box 45, an emergency stop switch 46, an audiovisual alarm 47, and a hand hammer 48. As shown in FIG. 8, the fourth compartment door 41 is designed with a window for the emergency hand pull box 45 and a window for the emergency stop switch 46 respectively for installing the emergency hand pull box 45 and the emergency stop switch 46 to facilitate emergency stop without opening the compartment door. The fourth compartment door 41 is designed with a window for the audiovisual alarm 47 for installing the audiovisual alarm 47, which can be used to send out alarms in the case of emergency. The fourth compartment door 41 is designed with the hand hammer 48 that can be used to smash open the panels of the window of the emergency stop switch 46 and the window of the emergency hand pull box 45 for emergency stop in the case of emergency.

The busbar compartment 50 is below the electrical compartment 40. The busbar compartment may be configured for mounting the busbar component. For example, a high voltage wire from the main control box compartment 20 may be connected to the busbar component through the wire slot 24 at the bottom of the box body. The busbar component, for example, may implement parallel connection of the multiple main control boxes.

Optionally, in an embodiment of this application, a side of the busbar component of the busbar compartment 50 farther away from the main control box compartment 20 may be provided with a transparent panel 52. For example, the transparent panel 52 made of acrylic may be designed directly in front of the busbar component to prevent accidental touch by people and entry of foreign objects. As shown in FIG. 1, the sealing panel assembly 51 is directly in front of the transparent panel 52, and the sealing panel assembly 51 has a seal ring that can be fastened to the box body through bolting or the like to seal the busbar compartment 50, which can prevent rainwater from entering inside to cause a short circuit.

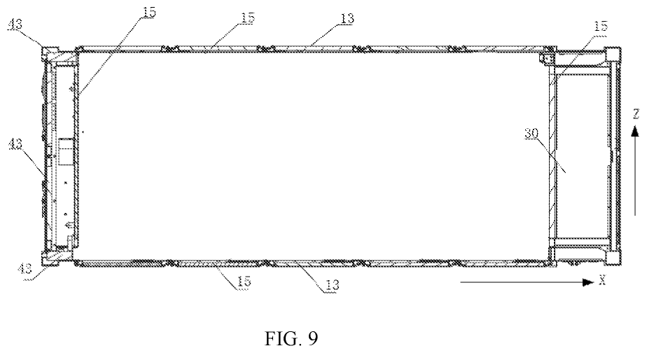

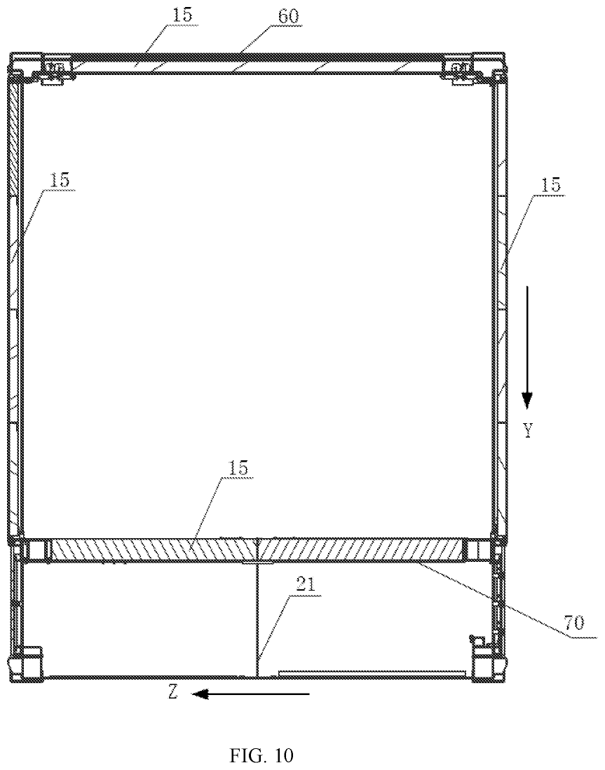

FIG. 9 is still another cross-sectional view of the energy storage container 1 in an embodiment of this application embodiment, and the cross-section may be any plane parallel to the top wall 60 of the container within the battery compartment 100. FIG. 10 is yet another cross-sectional view of the energy storage container 1 in an embodiment of this application, and the cross-section may be any plane perpendicular to the first direction X within any one of the battery compartments 100. Neither FIG. 9 nor FIG. 10 shows the side wall 11 shared by the multiple battery compartments 10. As shown in FIG. 9 and FIG. 10, the container 1 uses a sandwich structure in many places, and insulation cotton is provided in the middle of the sandwich structure to maintain temperature.

For example, as shown in FIG. 9 and FIG. 10, the outer wall of the multiple battery compartments 10 in the embodiment of this application is a first sandwich structure, where the first sandwich structure is provided with first insulation cotton 15, and the outer wall of the multiple battery compartments 10 is a wall other than the side wall 11 shared by two adjacent battery compartments 10 in the multiple battery compartments 10. Specifically, the outer walls of the multiple battery compartments 10 may include a top wall 60, a wall 70 shared with the main control box compartment 20, and a first compartment door 13, and may further include a wall shared between the battery compartments 10 and the electrical compartment 40 and a wall shared between the battery compartments 10 and the heat management component 30. The first insulation cotton 15 may be installed between two layers of sheet metal to form the first sandwich structure, which can reduce temperature difference in the battery compartment 10, prolong service life of the internal batteries, and prevent a large amount of condensed water produced in the battery compartment 10 from corroding the batteries.

For another example, as shown in FIG. 9 and FIG. 10, a wall of the electrical compartment 40 in the embodiment of this application is a second sandwich structure, where the second sandwich structure is provided with second insulation cotton 43. The wall of the electrical compartment 40 may include all six walls of the rectangular electrical compartment 40, and all or some of the six walls may be configured as the second sandwich structure. The second insulation cotton 43 may also be installed between two layers of sheet metal to form the second sandwich structure, which can reduce temperature difference inside the electrical compartment 40 and prolong service life of the internal electrical device.

The foregoing describes the energy storage container in the embodiments of this application, and the following describes a method and a device for manufacturing the energy storage container in the embodiments of this application. For content that is not described in detail, reference may be made to the foregoing embodiments.

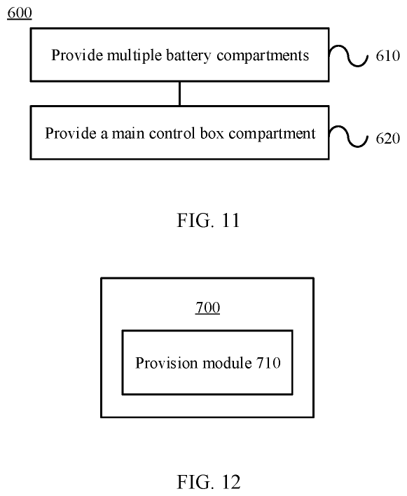

FIG. 11 is a schematic flowchart of a method 600 for manufacturing an energy storage container according to an embodiment of this application. As shown in FIG. 11, the method 600 may include: S610, providing multiple battery compartments 10, where the multiple battery compartments 10 are arranged consecutively in a first direction, each battery compartment 10 in the multiple battery compartments 10 is configured to accommodate multiple batteries, each battery compartment 10 in the multiple battery compartments includes a side wall 11 and a bracket 12, the bracket 12 is disposed on the side wall 11, the bracket 12 is configured to carry the batteries, and two adjacent battery compartments 10 in the multiple battery compartments 10 share a same side wall 11; and S620, providing a main control box compartment 20, where the main control box compartment 20 and the multiple battery compartments 10 are arranged in a second direction, the second direction being perpendicular to the first direction, and the main control box compartment 20 is configured to accommodate a main control box, the main control box being configured to electrically connect the batteries in the multiple battery compartments 10.

FIG. 12 is a schematic block diagram of a device 700 for manufacturing an energy storage container according to an embodiment of this application. As shown in FIG. 12, the device 700 may include a provision module 710. The provision module 710 is configured to: provide multiple battery compartments 10, where the multiple battery compartments 10 are arranged consecutively in a first direction, each battery compartment 10 in the multiple battery compartments 10 is configured to accommodate multiple batteries, each battery compartment 10 in the multiple battery compartments includes a side wall 11 and a bracket 12, the bracket 12 is disposed on the side wall 11, the bracket 12 is configured to carry the batteries, and two adjacent battery compartments 10 in the multiple battery compartments 10 share a same side wall 11; and provide a main control box compartment 20, where the main control box compartment 20 and the multiple battery compartments 10 are arranged in a second direction, the second direction being perpendicular to the first direction, and the main control box compartment 20 is configured to accommodate a main control box, the main control box being configured to electrically connect the batteries in the multiple battery compartments 10.

Although this application has been described with reference to the preferred embodiments, various modifications to this application and replacements with equivalents of the components herein can be made without departing from the scope of this application. In particular, as long as there is no structural conflict, the various technical features mentioned in the embodiments can be combined in any manners. This application is not limited to the specific embodiments disclosed in this specification, but includes all technical solutions falling within the scope of the claims.

1. An energy storage container, characterized by comprising:
multiple battery compartments arranged consecutively in a first direction, wherein each battery compartment in the multiple battery compartments is configured to accommodate multiple batteries, each battery compartment comprises a side wall and a bracket, the bracket is disposed on the side wall, the bracket is configured to carry the battery, and two adjacent battery compartments in the multiple battery compartments share a same side wall; and
a main control box compartment, wherein the main control box compartment and the multiple battery compartments are arranged in a second direction, the second direction being perpendicular to the first direction, and the main control box compartment is configured to accommodate a main control box, the main control box being configured to electrically connect the batteries in the multiple battery compartments.

2. The container according to claim 1, characterized in that the side wall shared by the two adjacent battery compartments is a corrugated plate.

3. The container according to claim 1, characterized in that a wall of each battery compartment comprises a first compartment door and a first wall intersecting with the first compartment door, wherein a plane in which the first compartment door is located is parallel to the first direction and the second direction, and
a first seal ring is provided between the first compartment door and the first wall so that when the first compartment door is closed, the battery compartment in which the first compartment door is located is sealed.

4. The container according to claim 1, characterized in that an outer wall of the multiple battery compartments is a first sandwich structure, wherein the first sandwich structure is provided with first insulation cotton, and the outer wall of the multiple battery compartments is a wall other than the side wall shared by two adjacent battery compartments in the multiple battery compartments.

5. The container according to claim 1, characterized in that a wall shared between the multiple battery compartments and the main control box compartment is provided with a drain valve, wherein the drain valve is configured to drain liquid from the battery compartments.

6. The container according to claim 1, characterized in that each battery compartment is configured to accommodate multiple columns of batteries arranged in a third direction, wherein each of the multiple columns of batteries comprises multiple batteries arranged in the second direction.

7. The container according to claim 6, characterized in that the container comprises multiple columns of the main control box compartments arranged in the third direction, wherein each column of the main control box compartments comprises the multiple main control box compartments arranged consecutively in the first direction.

8. The container according to claim 7, characterized in that a support beam is provided between two adjacent ones of the multiple columns of main control box compartments, wherein the support beam is configured to support the multiple battery compartments.

9. The container according to claim 8, characterized in that the support beam comprises an upper wing plate, a web plate, and a lower wing plate, wherein the upper wing plate and the lower wing plate are parallel to each other, the web plate connects the upper wing plate and the lower wing plate and is perpendicular to the upper wing plate and the lower wing plate,
the upper wing plate is attached to the wall shared between the multiple battery compartments and the main control box compartment, and
the web plate is a side wall shared between two adjacent columns of the main control box compartments.

10. The container according to claim 1, characterized in that a wall of the main control box compartment comprises a second compartment door and a second wall intersecting with the second compartment door, wherein a plane in which the second compartment door is located is parallel to the first direction and the second direction, and
a second seal ring is provided between the second compartment door and the second wall so that when the second compartment door is closed, the main control box compartment is sealed.

11. The container according to claim 1, characterized in that the container further comprises:
a heat management component compartment, wherein the multiple battery compartments and the heat management component compartment are arranged in the first direction, and the heat management component compartment is configured to accommodate a heat management component.

12. The container according to claim 11, characterized in that the main control box compartment is provided with a pipe clamp, wherein the pipe clamp is configured to fasten a water-cooled pipe, the water-cooled pipe is connected to the thermal management component, and the water-cooled pipe is disposed on a side of the main control box farther away from the multiple battery compartments.

13. The container according to claim 1, characterized in that the container further comprises:
an electrical compartment, wherein the electrical compartment and the multiple battery compartments are arranged in the first direction.

14. The container according to claim 13, characterized in that the electrical compartment is configured to accommodate at least one of the following components: a power distribution box, a general control box, a fire control box, and a fan.

15. The container according to claim 13, characterized in that a wall of the electrical compartment is a second sandwich structure, wherein the second sandwich structure is provided with second insulation cotton.

16. The container according to claim 13, characterized in that the wall of the electrical compartment comprises a fourth compartment door and a fourth wall intersecting with the fourth compartment door, wherein a plane in which the fourth compartment door is located is perpendicular to the first direction, and
a fourth seal ring is provided between the fourth compartment door and the fourth wall so that when the fourth compartment door is closed, the electrical compartment is sealed.

17. The container according to claim 1, characterized in that the container further comprises:
a busbar compartment, wherein the busbar compartment and the main control box compartment are arranged in the first direction, the busbar compartment is configured to accommodate a busbar component, and the busbar component is configured to be electrically connected to the main control box.

18. The container according to claim 17, characterized in that a side of the busbar component farther away from the main control box compartment is provided with a transparent panel, and a side of the transparent panel farther away from the busbar component is provided with a sealing panel assembly, wherein the sealing panel assembly is a wall of the busbar compartment, and the sealing panel assembly is configured to seal the busbar compartment.

19. A method for manufacturing an energy storage container, characterized by comprising:
providing multiple battery compartments consecutively arranged in a first direction, wherein each battery compartment in the multiple battery compartments is configured to accommodate multiple batteries, each battery compartment comprises a side wall and a bracket, the bracket is disposed on the side wall, the bracket is configured to carry the batteries, and two adjacent battery compartments in the multiple battery compartments share a same side wall; and
providing a main control box compartment, wherein the main control box compartment and the multiple battery compartments are arranged in a second direction, the second direction being perpendicular to the first direction, and the main control box compartment is configured to accommodate a main control box, the main control box being configured to electrically connect the batteries in the multiple battery compartments.

20. A device for manufacturing an energy storage container, characterized by comprising a provision module, wherein the provision module is configured to:
provide multiple battery compartments consecutively arranged in a first direction, wherein each battery compartment in the multiple battery compartments is configured to accommodate multiple batteries, each battery compartment comprises a side wall and a bracket, the bracket is disposed on the side wall, the bracket is configured to carry the batteries, and two adjacent battery compartments in the multiple battery compartments share a same side wall; and
provide a main control box compartment, wherein the main control box compartment and the multiple battery compartments are arranged in a second direction, the second direction being perpendicular to the first direction, and the main control box compartment is configured to accommodate a main control box, the main control box being configured to electrically connect the batteries in the multiple battery compartments.
